(19) United States
(12) Patent Application Publication
(10) Pub. No.: US 2023/0336236 A1
(43) Pub. Date: Oct. 19, 2023

(54) SPATIAL MODULATION SYSTEM AND METHOD FOR GENERATING TRAINING SEQUENCES

(71) Applicant: National Cheng Kung University, Tainan City (TW)

(72) Inventors: Chao-Yu CHEN, Tainan City (TW); Zhen-Ming HUANG, Tainan City (TW)

(73) Assignee: National Cheng Kung University, Tainan City (TW)

(21) Appl. No.: 17/828,867

(22) Filed: May 31, 2022

(30) Foreign Application Priority Data
Apr. 14, 2022 (TW) 111114334

(51) Int. Cl. H04B 7/08; H04J 13/00

(52) U.S. Cl. CPC H04B 7/0851; H04B 7/0854; H04J 13/0014

(57) ABSTRACT

A spatial modulation system and a method for generating training sequences are provided. The method for generating training sequences includes: obtaining a cross Z-complementary set (CZCS); and obtaining a training sequence matrix according to cross Z-complementary sequences in the CZCS. Therefore, a larger zero correlation zone (ZCZ) width can be constructed, and the constructed sequence set has flexible lengths.

### CROSS-REFERENCE TO RELATED APPLICATION

This non-provisional application claims priority under 35 U.S.C. § 119(a) to Patent Application No. 111114334 filed in Taiwan, R.O.C. on Apr. 14, 2022, the entire contents of which are hereby incorporated by reference.

### BACKGROUND

### Technical Field

The present invention relates to a communication technology, and in particular, to a spatial modulation system and a method for generating training sequences.

### Related Art

Single carrier spatial modulation is a special type of multiple-input multiple-output (MIMO) technology, and has zero inter-channel interference (ICI), lower power consumption, and lower transmitter hardware complexity on flat fading channels. This is because only one radio frequency chain is required in a single carrier spatial modulation system, and only one transmit antenna is activated on each timeslot. However, the current researches mostly assume that perfect channel state information (CSI) at a receive end is known.

### SUMMARY

In view of this, the present invention provides a method for generating training sequences, including: obtaining a cross Z-complementary set (CZCS), where the CZCS includes cross Z-complementary sequences c₀˜c_{N-1}, and a length of each of the cross Z-complementary sequences is L; and obtaining a training sequence matrix Λ according to the cross Z-complementary sequences, where

$$Λ = [ \begin{matrix}{x}_{1} \\ {x}_{2} \\ ⋮ \\ {x}_{{N}_{t}}\end{matrix} ] = {[ \begin{matrix}{c}_{0} & 0 & … & 0 & {c}_{1} & 0 & … & 0 & {c}_{2} & 0 & … & 0 & & {c}_{N - 1} & 0 & … & 0 \\ 0 & {c}_{0} & … & 0 & 0 & {c}_{1} & … & 0 & 0 & {c}_{2} & … & 0 & … & 0 & {c}_{N - 1} & … & 0 \\ ⋮ & ⋮ & ⋱ & ⋮ & ⋮ & ⋮ & ⋱ & ⋮ & ⋮ & ⋮ & ⋱ & ⋮ & & ⋮ & ⋮ & ⋱ & ⋮ \\ 0 & 0 & … & {c}_{0} & 0 & 0 & … & {c}_{1} & 0 & 0 & … & {c}_{2} & & 0 & 0 & … & {c}_{N - 1}\end{matrix} ]}_{{N}_{t} \times {NN}_{t} L}$$

where 0 is a zero vector 0_{1xL}.

The present invention further provides a spatial modulation system, including: a sequence generation circuit and a communication circuit. The sequence generation circuit is configured to perform the foregoing method for generating training sequences. The communication circuit is configured to transmit the training sequence matrix.

In summary, the spatial modulation system according to some embodiments of the present invention can achieve good channel estimation performance on frequency selective channels. In the method for generating training sequences according to some embodiments of the present invention, a larger zero correlation zone (ZCZ) width can be constructed (or even the ZCZ ratio can reach 1), so that the training sequences can resist a larger channel propagation delay; and the constructed sequence set has flexible lengths (including even lengths and odd lengths), thereby improving the actual usability of the system.

### BRIEF DESCRIPTION OF THE DRAWINGS

FIG. 1 is a schematic diagram of a hardware architecture of a spatial modulation system according to an embodiment of the present invention.

FIG. 2 is a schematic diagram of transmit blocks of a communication circuit according to an embodiment of the present invention.

FIG. 3 is a schematic diagram of a training sequence part according to an embodiment of the present invention.

FIG. 4 is a flowchart of a method for generating training sequences according to an embodiment of the present invention.

FIG. 5 is a schematic diagram of a training sequence matrix according to an embodiment of the present invention.

FIG. 6 is a schematic diagram of a training sequence matrix according to another embodiment of the present invention.

### DETAILED DESCRIPTION

The following symbols are used in this specification, and meanings of the symbols are described first herein:

“a∥b” represents a sequence a concatenating a sequence b.

+ represents 1, and − represents −1.

ã represents reverse of the sequence a.

* represents a bit-interleaved operation.

X* represents a complex conjugate of a matrix X.

X^{T} represents transpose of the matrix X.

X^{H} represents Hermitian transpose of the matrix X.

Tr(X) represents trace of the matrix X.

I_{M} represents an identity matrix with a size of M.

E(x) represents a mean of a random variable x.

The following describes an aperiodic cross-correlation function (ACCF) ρ(c, d;u), as shown in Formula 1. The sequence c is (c₀, c₁, . . . , c_{L}_{₁}₋₁), and a length is L₁; and the sequence d is (d₀, d₁, . . . , d_{L}_{₂}₋₁), a length is L₂, and a shift is represented by u.

$$ρ ( c , d ; u ) = \{ \begin{matrix}{\sum }_{k = 0}^{{L}_{1} - 1 - u} {c}_{k + u} {d}_{k}^{*} , 0 \leq u \leq {L}_{1} - 1 \\ {\sum }_{k = 0}^{{L}_{1} - 1 + u} {c}_{k} {d}_{k - u}^{*} , - {L}_{1} + 1 \leq u < 0\end{matrix} \qquad ( Formula 1 )$$

Herein, for i≠0, 1, . . . L₂−1, dᵢ=0.

Further, when the sequence c is the same as the sequence d, ρ(c, c;u)=ρ(c;u), which represents an aperiodic autocorrelation function (AACF) of the sequence c.

In addition, a periodic cross-correlation function (PCCF) is expressed in Formula 2. Similarly, the sequence c is (c₀, c₁, . . . , C_{L}_{₁}₋₁), and a length is L₁; and the sequence d is (d₀, d₁, . . . , d_{L}_{₂}₋₁), a length is L₂, and a shift is represented by u.

$$\hat{ρ} ( c , d ; u ) = \{ \begin{matrix}{\sum }_{k = 0}^{{L}_{1} - 1} {c}_{{( k + u )}_{mod {L}_{1}}} {d}_{k}^{*} , & 0 \leq u \leq {L}_{1} - 1 \\ {\sum }_{k = 0}^{{L}_{1} - 1} {c}_{k} {d}_{{( k - u )}_{mod {L}_{1}}}^{*} , & - {L}_{1} + 1 \leq u < 0\end{matrix} \qquad ( Formula 2 )$$

Similarly, a periodic autocorrelation function (PACF) of sequence c is expressed as \hat{ρ}(c, c;u)=\hat{ρ}(c;u).

The following describes a definition of a Golay complementary set (GCS). A complementary sequence set C={c₀, c₁, . . . , c_{N-1}} includes N complex sequences with a length of L, and each complex sequence is expressed as cₖ=(c₀, c₁, . . . , c_{L-1}), where k=0, 1, . . . , N−1. When the condition of Formula 3 is met, the complementary sequence set C is a GCS, and is expressed as (N, L)-GCS. When N=2, the GCS is a Golay complementary pair (GCP).

$${\sum }_{k = 0}^{N - 1} ρ ( {c}_{k} ; u ) = \{ \begin{matrix}0 , & u \neq 0 \\ NL , & u = 0\end{matrix} \begin{matrix} \\ \end{matrix} \qquad ( Formula 3 )$$

If Formula 4 is met, a sequence pair (d₀, d₁) is a mate of a sequence pair (c₀, c₁). In addition, for the sequence pair (c₀, c₁), one of the mates is constructed through (d₀, d₁)=( [symbol] ,− [symbol] ).

ρ(c₀,d₀;u)+ρ(c₁,d₁;u)=0, for all u (Formula 4)

The following describes a cross Z-complementary set (CZCS), which is expressed as (N, L, Z)-CZCS and meets Formula 5-1 and Formula 5-2. N is a sequence number, L is a sequence length, Z is a zero correlation zone (ZCZ) width, and N, L, and Z are positive integers. A zone T₁ [symbol] {1, 2, . . . , Z}, a zone T₂ [symbol] {L−Z, L−Z+1, . . . , L−1}, and a zone T_{L} [symbol] {1, 2, . . . , L−1}. If N=2, the CZCS is a cross Z-complementary pair (CZCP), and is expressed as (L, Z)-CZCP. According to Formula 5-1 and Formula 5-2, the CZCS has two zero autocorrelation zones (ZACZs) and one zero cross-correlation zone (ZCCZ). When Z≥L/2, it indicates that the sequence set C meets Formula 5-1 and u≠0. In this case, the sequence set C is a GCS. However, the GCS does not meet Formula 5-2.

Σₖ₌₀^{N-1}ρ(cₖ;u)=0, for all |u|∈(T₁∪T₂)∩T_{L} (Formula 5-1)

Σₖ₌₀^{N-1}ρ(cₖ,c_{(k+1)mod N};u)=0, for all |u|∈T₂ (Formula 5-2)

For the (L, Z)-CZCP, a maximum value of Z is L/2. A case in which Z=L/2 and L is an even number is referred to as a perfect CZCP (expressed as (L, L/2)-CZCP) or a strengthened GCP. The CZCP has only even sequence lengths. For a (N, L, Z)-CZCS in which N>2, a value of the ZCZ width Z is at most L. A (N, L, L)-CZCS in which Z is equal to L is referred to as a perfect CZCS.

A sum of the AACF and a sum of the ACCF of the perfect (N, L, L)-CZCS are both 0 (for all shifts u). According to Formula 5-1 and Formula 5-2, (T₁∪T₂)∩T_{L}={1, 2, . . . , L−1}, and T₂={0, 1, . . . , L−1}. It can be learned that the perfect CZCS (N, L, L)-CZCS is also a GCS.

Herein, the ZCZ ratio

$$Z C {Z}_{ratio} = \frac{Z}{L}$$

of the (N, L, Z)-CZCS is additionally defined.

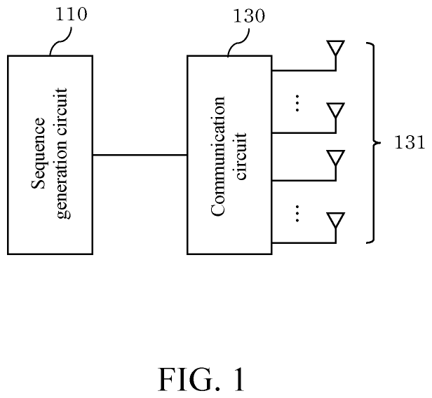

FIG. 1 is a schematic diagram of a hardware architecture of a spatial modulation system according to an embodiment of the present invention. The spatial modulation system (for example, a single carrier spatial modulation system) is a multi-antenna transmission system, including a sequence generation circuit 110 and a communication circuit 130. The communication circuit 130 includes Nₜ transmit antennas 131. The sequence generation circuit 110 is configured to generate training sequences required by the communication circuit 130.

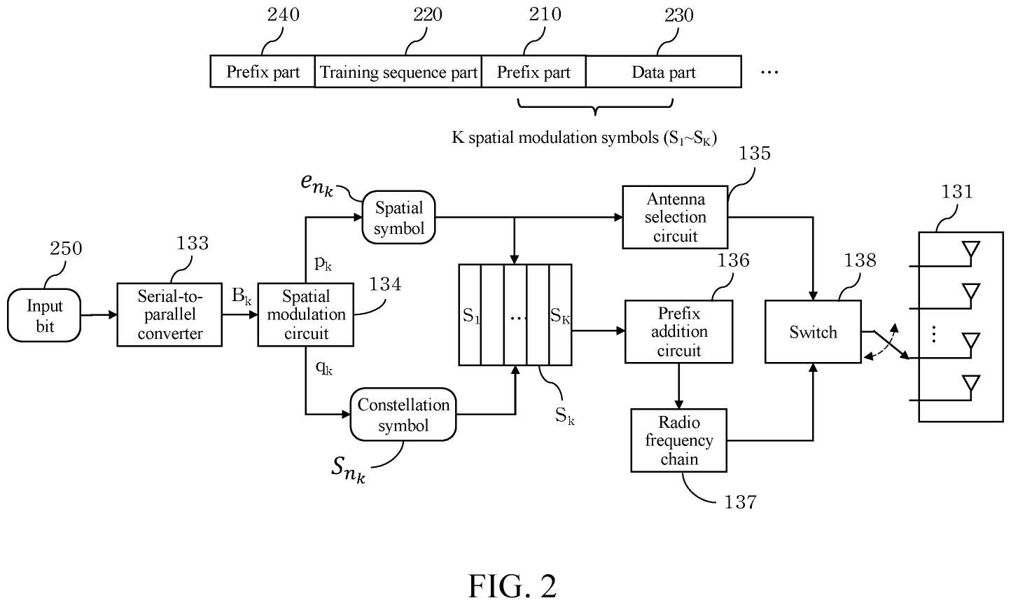

FIG. 2 is a schematic diagram of transmit blocks of the communication circuit 130 according to an embodiment of the present invention. An input bit 250 is converted into a vector Bₖ by a serial-to-parallel converter 133, and is modulated to a carrier by a spatial modulation circuit 134. The spatial modulation circuit 134 may use quadrature amplitude modulation (QAM) or phase shift keying (PSK). A constellation size is represented by M_{SM}. When a signal is transmitted in channels, the signal suffers from inter-symbol interference (ISI) and inter-channel interference (ICI) due to the impact of the channels. To prevent the signal from being affected by the interference, in addition to a data part 230, the transmitted signal further includes a protection zone extending before the data part 230, that is, a prefix part 210. The prefix part 210 is cyclic prefix (CP) or zero padding. The data part 230 is segmented into K timeslots, and each timeslot has log₂(NₜM_{SM}) bits, which are mapped to a spatial modulation symbol Sₖ, where k=1, 2, . . . , K. Each vector B_{K} is separately split according to vector lengths of log₂(Nₜ) and log₂(M_{SM}), to respectively obtain a vector pₖ and a vector qₖ. In each timeslot, one of the Nₜ transmit antennas 131 indicated by the vector pₖ is activated. The vector pₖ is mapped to a column vector eₙ_{ₖ}, which is the nₖth column of an identity matrix I_{N}_{ₜ}. The vector pₖ is the binary representation vector of nₖ. Further, nₖ represents an index of the selected transmit antenna 131, so that an antenna selection circuit 135 controls a switch 138 according to the index to select a corresponding transmit antenna 131. A constellation symbol Sₙ_{ₖ} is selected through the vector qₖ. The spatial modulation symbol Sₖ is expressed as Formula 6. Then, a prefix addition circuit 136 adds the prefix part 210, which includes supplementary CP or zero padding. Next, the transmitted signal is sent through a radio frequency chain 137 and the transmit antenna 131.

$${S}_{k} = {S}_{{n}_{k}} {e}_{{n}_{k}} = {[ {\underbrace{0 , … , 0}}_{{n}_{k} - 1} , {S}_{{n}_{k}} , {\underbrace{0 , … , 0}}_{{N}_{t} - {n}_{k}} ]}^{T} \qquad ( Formula 6 )$$

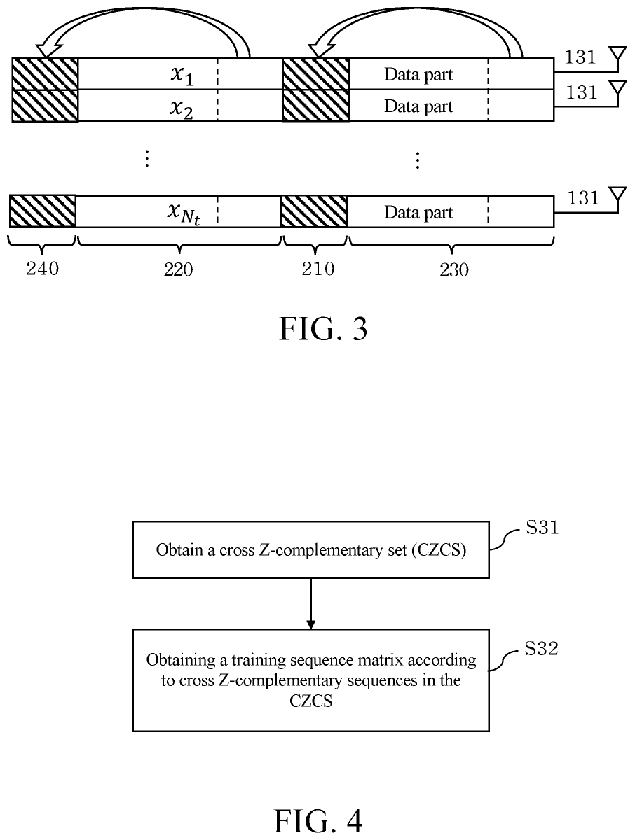

The following describes a training sequence part 220, located before the data part 230 and the prefix part 210. There is another prefix part 240 before the training sequence part 220. The prefix part 240 is CP or zero padding. The prefix part 240 is also added by the prefix addition circuit 136, and includes supplementary CP or zero padding. FIG. 3 is a schematic diagram of the training sequence part 220 according to an embodiment of the present invention. The training sequence part 220 corresponding to each transmit antenna 131 includes a training sequence, x₁, x₂, . . . , x_{N}_{ₜ}, and the training sequences form a training sequence matrix Λ=[x₁^{T}, x₂^{T}, . . . , x_{N}_{ₜ}^{T}]^{T}.

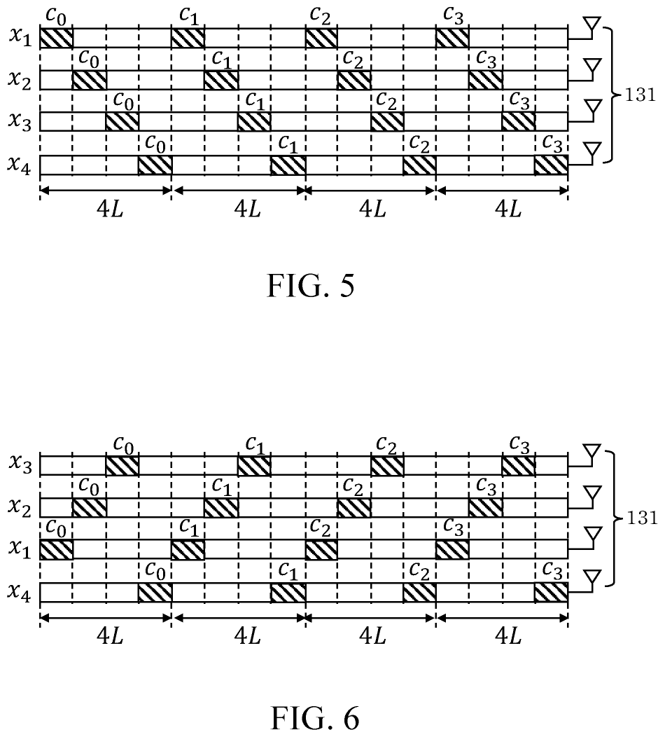

Referring to FIG. 4 and FIG. 5 together, FIG. 4 is a flowchart of a method for generating training sequences according to an embodiment of the present invention, and FIG. 5 is a schematic diagram of the training sequence matrix Λ according to an embodiment of the present invention. First, in step S31, a (N, L, Z)-CZCS={c₀, c₁, c₂, c_{N-1}} is obtained, and N=4 is used as an example herein. Then, in step S32, a training sequence matrix Λ is obtained according to cross Z-complementary sequences in the (N, L, Z)-CZCS. The training sequence matrix Λ is shown in Formula 7, where 0 is a zero vector 0_{1xL}. It can be learned that only one transmit antenna 131 is activated in each timeslot.

$$Λ = [ \begin{matrix}{x}_{1} \\ {x}_{2} \\ ⋮ \\ {x}_{{N}_{t}}\end{matrix} ] = {[ \begin{matrix}{c}_{0} & 0 & ⋯ & 0 & {c}_{1} & 0 & ⋯ & 0 & {c}_{2} & 0 & ⋯ & 0 & & {c}_{N - 1} & 0 & ⋯ & 0 \\ 0 & {c}_{0} & ⋯ & 0 & 0 & {c}_{1} & ⋯ & 0 & 0 & {c}_{2} & ⋯ & 0 & … & 0 & {c}_{N - 1} & ⋯ & 0 \\ ⋮ & ⋮ & ⋱ & ⋮ & ⋮ & ⋮ & ⋱ & ⋮ & ⋮ & ⋮ & ⋱ & ⋮ & & ⋮ & ⋮ & ⋱ & ⋮ \\ 0 & 0 & … & {c}_{0} & 0 & 0 & … & {c}_{1} & 0 & 0 & … & {c}_{2} & & 0 & 0 & … & {c}_{N - 1}\end{matrix} ]}_{{N}_{t} \times {NN}_{t} L} \qquad ( Formula 7 )$$

As shown in FIG. 5, it can be learned that each training sequence xₙ in the training sequence matrix Λ has a length of L′=NNₜL, where n=1, 2, . . . , Nₜ, and includes NL non-zero entries and N(Nₜ−1)L zero vectors. The training sequence xₙ is transmitted by a nₖ th transmit antenna 131. Assuming that the training sequence xₙ=(x_{n,0}, x_{n,1}, . . . , x_{n,L′-1}), each transmit antenna 131 includes λ+1 multipaths and a zero mean in an additive white Gaussian noise (AWGN) channel, and a variance in each dimension is σ²/2. All the training sequences xₙ have the same energy E, as shown in Formula 8.

Σₜ₌₀^{L′-1}|x_{n,t}|²=E, for n=1,2, . . . ,Nₜ (Formula 8)

Through a least square (LS) channel estimator, a standardized mean square error (MSE) is shown in Formula 9. X is an L′×Nₜ(λ+1) matrix. If the condition of Formula 10 is met, a minimum

$$M S E = \frac{{σ}^{2}}{E}$$

can be reached.

$$MSE = \frac{{σ}^{2}}{{N}_{t} λ + {N}_{t}} {T}_{r} ( {( {X}^{H} X )}^{- 1} ) \qquad ( Formula 9 )$$

$$\hat{ρ} ( {x}_{i} , {x}_{j} ; u ) = \{ \begin{matrix}E , & if i = j , u = 0 \\ 0 , & if i \neq j , 0 \leq u \leq λ , or i = j , 1 \leq u \leq λ\end{matrix} \qquad ( Formula 10 )$$

It is noted herein that the training sequence matrix Λ (if Z>λ) provided in the present invention can meet Formula 10, that is, the foregoing minimum MSE can be reached. When a sequence set {c₀, c₁, c₂, c₃} is a (4, L, Z)-CZCS, Formula 11 and Formula 12 can be obtained according to Formula 5-1, and Formula 13 can be obtained according to Formula 5-2. It can be learned with reference to Formula 11, Formula 12, and Formula 13 that if the condition of Formula 10 is met, the foregoing minimum MSE can be reached. In frequency selective channels, the property of the CZCS (Formula 5-1) can eliminate ICI between an i^{th} transmit antenna 131 and an (i+1)^{th} transmit antenna 131 and ISI caused by a multipath delay. In addition, inter-carrier interference between the first transmit antenna 131 and an Nₜ^{th} transmit antenna 131 can be eliminated by the property of the CZCS (Formula 5-2), so that the spatial modulation system can achieve good channel estimation performance on the frequency selective channels.

$$\hat{ρ} ( {x}_{i + 1} , {x}_{i} ; u ) = {\sum }_{k = 0}^{3} {ρ}^{*} ( {c}_{k} ; L - u ) = 0 , \qquad ( Formula 11 )$$

$$for 1 \leq u \leq Z , 1 \leq i \leq {N}_{t} - 1$$

$$\hat{ρ} ( {x}_{i} , {x}_{i} ; u ) = \hat{ρ} ( {x}_{i} ; u ) = {\sum }_{k = 0}^{3} {ρ}^{*} ( {c}_{k} ; u ) = 0 , \qquad ( Formula 12 )$$

$$for 1 \leq u \leq Z , 1 \leq i \leq {N}_{t}$$

$$\hat{ρ} ( {x}_{1} , {x}_{{N}_{t}} ; u ) = {\sum }_{k = 0}^{3} {ρ}^{*} ( {c}_{k} , {c}_{( k + 1 ) mod 4} ; L - u ) = 0 , \qquad ( Formula 13 )$$

$$for 1 \leq u \leq Z$$

In some embodiments, FIG. 6 is a schematic diagram of the training sequence matrix Λ according to another embodiment of the present invention. A sequence between training sequences xₙ in the training sequence matrix Λ may be mutually adjusted, and does not necessarily correspond to the transmit antennas 131 sequentially. For example, corresponding to the transmit antennas 131 in the same sequence shown in FIG. 5, the sequence of the training sequences in the training sequence matrix Λ in FIG. 6 is different from the sequence of the training sequences in FIG. 5. In FIG. 6, the training sequences in the training sequence matrix Λ are sequentially {x₃, x₂, x₁, x₄}.

Then, the following describes a construction manner of the (N, L, Z)-CZCS provided in some embodiments of the present invention. For ease of description, N=4 is used for description below.

Construction manner 1: The CZCS {c₀, c₁, c₂, c₃} is formed by amplifying a seed sequence pair. Specifically, {c₀, c₁, c₂, c₃}={a, b, −a, b}, and the seed sequence pair (a, b) is a (L, Z)-CZCP or a GCP with a length of L. In this case, a (4, L, Z)-CZCS is constructed based on a CZCP; or a (4, L, L)-CZCS is constructed based on a GCP.

It is proved herein that the sequence set constructed in the construction manner 1 indeed belongs to the CZCS (meets Formula 5-1 and Formula 5-2), which is discussed in two cases.

Case 1: When a seed sequence pair (a, b) is a (L, Z)-CZCP, Formula 5-1 is met, as shown below:

$${\sum }_{k = 0}^{3} ρ ( {c}_{k} ; u ) = 2 ( ρ ( a ; u ) + ρ ( b ; u ) ) = 0 , for \vert u \vert ∈ {T}_{1} ⋃ {T}_{2}$$

Case 2: For |u|∈T₂, Formula 5-2 is met, as shown below:

$$\begin{matrix}{\sum }_{k = 0}^{3} ρ ( {c}_{k} , {c}_{( k + 1 ) mod 4} ; u ) \\ = ρ ( a , b ; u ) + ρ ( b , - a ; u ) + ρ ( - a , b ; u ) + ρ ( b , a ; u ) \\ = ρ ( a , b ; u ) - ρ ( a , b ; u ) + ρ ( b , a ; u ) - ρ ( b , a ; u ) = 0\end{matrix}$$

It can be learned from the foregoing two cases that when the seed sequence pair (a, b) is a CZCP, the sequence set constructed in the construction manner 1 indeed belongs to the CZCS.

Further, if the seed sequence pair (a, b) is a GCP with a length of L, Z is L−1. In addition, for a status of u=0 in case 2, Formula 5-2 is also met, as shown below. Therefore, if the seed sequence pair (a, b) is a GCP, a perfect (4, L, L)-CZCS is constructed in the construction manner 1.

$$\begin{matrix}{\sum }_{k = 0}^{3} ρ ( {c}_{k} , {c}_{( k + 1 ) mod 4} ; 0 ) \\ = ρ ( a , b ; 0 ) - ρ ( a , b ; 0 ) + ρ ( b , a ; 0 ) - ρ ( b , a ; 0 ) = 0\end{matrix}$$

In some embodiments, if the seed sequence pair (a, b) is also the foregoing (L, Z)-CZCP, each sequence set listed below is also the (4, L, Z)-CZCS: {−a, b, a, b}, {a, −b, a, b}, and {a, b, a, −b}.

In some embodiments, if the seed sequence pair (a, b) is a GCP, each sequence set listed below is also the perfect (4, L, L)-CZCS: {−a, b, a, b}, {a, −b, a, b}, and {a, b, a, −b}.

Construction manner 2: The CZCS {c₀, c₁, c₂, c₃} is formed by concatenating sequences in two seed sequence pairs. Specifically, c₀=a∥c, c₁=b∥d, c₂=(−a)∥c, and c₃=(−b)∥d. The two seed sequence pairs (a, b) and (c, d) are GCPs with respective lengths of L₁ and L₂, and (c, d) is also a CZCP (L₂, Z₂)-CZCP. L₁≤L₂. In this case, a (4, L₁+L₂, min(L₂, L₁+Z₂))-CZCS is constructed based on the two seed sequence pairs (a, b) and (c, d).

It is proved herein that the sequence set constructed in the construction manner 2 indeed belongs to the CZCS (meets Formula 5-1 and Formula 5-2), which is discussed in three cases.

Case 1: If L₁=L₂, Formula 5-1 and Formula 5-2 are both met, as shown below. The sequence set is a (4, L₁+L₂, L₂)-CZCS.

$$\begin{matrix}{\sum }_{k = 0}^{3} ρ ( {c}_{k} ; u ) = \{ \begin{matrix}2 ( ρ ( a ; u ) + ρ ( b ; u ) ) + 2 ( ρ ( c ; u ) + ρ ( d ; u ) ) \\ + {ρ}^{*} ( a , c ; {L}_{1} - u ) + {ρ}^{*} ( - a , c ; {L}_{1} - u ) \\ + {ρ}^{*} ( b , d ; {L}_{1} - u ) + {ρ}^{*} ( - b , d ; {L}_{1} - u ) , \\ for 1 \leq u < {L}_{1} ; \\ ρ ( c , a ; u - {L}_{1} ) + ρ ( c , - a ; u - {L}_{1} ) \\ + ρ ( d , b ; u - {L}_{1} ) + ρ ( d , - b ; u - {L}_{1} ) , \\ for {L}_{1} \leq u < {L}_{1} + {L}_{2}\end{matrix} \\ = \{ \begin{matrix}0 , & for 1 \leq u < {L}_{1} ; \\ 0 , & for {L}_{1} \leq u < {L}_{1} + {L}_{2}\end{matrix}\end{matrix}$$

$$\begin{matrix}{\sum }_{k = 0}^{3} ρ ( {c}_{k} , {c}_{( k + 1 ) mod 4} ; u ) \\ ρ ( c , b ; u - {L}_{1} ) - ρ ( d , a ; u - {L}_{1} ) - ρ ( c , b ; u - {L}_{1} ) + ρ ( d , a ; u - {L}_{1} ) = 0 , \\ for {L}_{1} \leq u < {L}_{1} + {L}_{2}\end{matrix}$$

Case 2: If L₂−Z₂≤L₁<L₂, Formula 5-1 and Formula 5-2 are both met, as shown below. The sequence set is a (4, L₁+L₂, L₂)-CZCS.

$$\begin{matrix}{\sum }_{k = 0}^{3} ρ ( {c}_{k} ; u ) = \{ \begin{matrix}2 ( ρ ( a ; u ) + ρ ( b ; u ) ) + 2 ( ρ ( c ; u ) + ρ ( d ; u ) ) \\ + {ρ}^{*} ( a , c ; {L}_{1} - u ) + {ρ}^{*} ( - a , c ; {L}_{1} - u ) \\ + {ρ}^{*} ( b , d ; {L}_{1} - u ) + {ρ}^{*} ( - b , d ; {L}_{1} - u ) , \\ for 1 \leq u < {L}_{1} ; \\ 2 ( ρ ( c ; u ) + ρ ( d ; u ) ) + ρ ( c , a ; u - {L}_{1} ) \\ + ρ ( c , - a ; u - {L}_{1} ) + ρ ( d , b ; u - {L}_{1} ) \\ + ρ ( d , - b ; u - {L}_{1} ) , \\ for {L}_{1} \leq u < {L}_{2} ; \\ ρ ( c , a ; u - {L}_{1} ) + ρ ( c , - a ; u - {L}_{1} ) \\ + ρ ( d , b ; u - {L}_{1} ) + ρ ( d , - b ; u - {L}_{1} ) , \\ for {L}_{2} \leq u < {L}_{1} + {L}_{2}\end{matrix} \\ = \{ \begin{matrix}0 , & for 1 \leq u < {L}_{1} ; \\ 0 , & for {L}_{1} \leq u < {L}_{2} ; \\ 0 , & for {L}_{2} \leq u < {L}_{1} + {L}_{2}\end{matrix}\end{matrix}$$

$$\begin{matrix}{\sum }_{k = 0}^{3} ρ ( {c}_{k} , {c}_{( k + 1 ) mod 4} ; u ) = \{ \begin{matrix}2 ( ρ ( c , d ; u ) + ρ ( d , c ; u ) ) \\ + ρ ( c , b ; u - {L}_{1} ) + ρ ( c , - b ; u - {L}_{1} ) \\ + ρ ( d , a ; u - {L}_{1} ) + ρ ( d , - a ; u - {L}_{1} ) , \\ for {L}_{1} \leq u < {L}_{2} ; \\ ρ ( c , b ; u - {L}_{1} ) + ρ ( c , - b ; u - {L}_{1} ) \\ + ρ ( d , a ; u - {L}_{1} ) + ρ ( d , - a ; u - {L}_{1} ) , \\ for {L}_{2} \leq u < {L}_{1} + {L}_{2}\end{matrix} \\ = \{ \begin{matrix}0 , & for {L}_{1} \leq u < {L}_{2} ; \\ 0 , & for {L}_{2} \leq u < {L}_{1} + {L}_{2}\end{matrix}\end{matrix}$$

Case 3: If L₁<L₂−Z₂<L₂, Formula 5-1 and Formula 5-2 are both met, as shown below. The sequence set is a (4, L₁+L₂, L₁+Z₂)-CZCS.

$$\begin{matrix}{\sum }_{k = 0}^{3} ρ ( {c}_{k} ; u ) = \{ \begin{matrix}2 ( ρ ( a ; u ) + ρ ( b ; u ) ) + 2 ( ρ ( c ; u ) + ρ ( d ; u ) ) \\ + {ρ}^{*} ( a , c ; {L}_{1} - u ) + {ρ}^{*} ( - a , c ; {L}_{1} - u ) \\ + {ρ}^{*} ( b , d ; {L}_{1} - u ) + {ρ}^{*} ( - b , d ; {L}_{1} - u ) , \\ f o r 1 \leq u < {L}_{1} ; \\ 2 ( ρ ( c ; u ) + ρ ( d ; u ) ) + ρ ( c , a ; u - {L}_{1} ) \\ + ρ ( c , - a ; u - {L}_{1} ) + ρ ( d , b ; u - {L}_{1} ) \\ + ρ ( d , - b ; u - {L}_{1} ) , \\ f o r {L}_{1} \leq u < {L}_{2} ; \\ ρ ( c , a ; u - {L}_{1} ) + ρ ( c , - a ; u - {L}_{1} ) \\ + ρ ( d , b ; u - {L}_{1} ) + ρ ( + d , - b ; u - {L}_{1} ) , \\ f o r {L}_{2} \leq u < {L}_{1} + {L}_{2}\end{matrix} \\ = \{ \begin{matrix}0 , & for 1 \leq u < {L}_{1} ; \\ 0 , & for {L}_{1} \leq u < {L}_{2} ; \\ 0 , & for {L}_{2} \leq u < {L}_{1} + {L}_{2}\end{matrix}\end{matrix}$$

$$\begin{matrix}{\sum }_{k = 0}^{3} ρ ( {c}_{k} , {c}_{( k + 1 ) mod 4} ; u ) = \{ \begin{matrix}2 ( ρ ( c , d ; u ) + ρ ( d , c ; u ) ) \\ + ρ ( c , b ; u - {L}_{1} ) + ρ ( c , - b ; u - {L}_{1} ) \\ + ρ ( d , a ; u - {L}_{1} ) + ρ ( d , - a ; u - {L}_{1} ) , \\ for {L}_{1} \leq u < {L}_{2} - {Z}_{2} ; \\ 2 ( ρ ( c , b ; u ) + ρ ( d , c ; u ) ) \\ + ρ ( c , b ; u - {L}_{1} ) + ρ ( c , - b ; u - {L}_{1} ) \\ + ρ ( d , a ; u - {L}_{1} ) + ρ ( d , - a ; u - {L}_{1} ) , \\ for {L}_{2} - {Z}_{2} \leq u < {L}_{2} ; \\ ρ ( c , b ; u - {L}_{1} ) + ρ ( c , - b ; u - {L}_{1} ) \\ + ρ ( d , a ; u - {L}_{1} ) + ρ ( d , - a ; u - {L}_{1} ) , \\ for {L}_{2} \leq u < {L}_{1} + {L}_{2}\end{matrix} \\ = \{ \begin{matrix}2 ( ρ ( c , d ; u ) + ρ ( d , c ; u ) ) , & for {L}_{1} \leq u < {L}_{2} - {Z}_{2} ; \\ 0 , & for {L}_{2} - {Z}_{2} \leq u < {L}_{2} ; \\ 0 , & for {L}_{2} \leq u < {L}_{1} + {L}_{2}\end{matrix}\end{matrix}$$

With reference to the foregoing three cases, the (4, L₁+L₂, Z)-CZCS is constructed in the construction manner 2.

$$\begin{matrix}Z = \{ \begin{matrix}{L}_{2} , & if {L}_{1} = {L}_{2} \\ {L}_{2} , & if {L}_{1} \geq {L}_{2} - {Z}_{2} \\ {L}_{1} + {Z}_{2} , & if {L}_{2} - {Z}_{2} > {L}_{1}\end{matrix} \\ = \{ \begin{matrix}{L}_{2} , & if {L}_{1} = {L}_{2} \\ {L}_{2} , & if {L}_{1} + {Z}_{2} \geq {L}_{2} \\ {L}_{1} + {Z}_{2} , & if {L}_{2} > {L}_{1} + {Z}_{2}\end{matrix} \\ = min ( {L}_{2} , {L}_{1} + {Z}_{2} )\end{matrix}$$

Construction manner 3: The CZCS {c₀, c₁, c₂, c₃} is formed by concatenating sequences in a seed sequence set. Specifically, c₀=g₀∥g₁, c₁=g₂∥g₃, c₂=g₀∥(−g₁), and c₃=g₂∥(−g₃). The seed sequence set {g₀, g₁, g₂, g₃} is a (4, L)-GCS. In this case, a (4, 2L, L)-CZCS is constructed based on a GCS {g₀, g₁, g₂, g₃}.

It is proved herein that the sequence set constructed in the construction manner 3 indeed belongs to the CZCS (meets Formula 5-1 and Formula 5-2), which is discussed in three cases.

Case 1: For 1≤u≤L−1, Formula 5-1 is met, as shown below:

$$\begin{matrix}{\sum }_{k = 0}^{3} ρ ( {c}_{k} ; u ) = 2 ( ρ ( {g}_{0} ; u ) + ρ ( {g}_{1} ; u ) + ρ ( {g}_{2} ; u ) + ρ ( {g}_{3} ; u ) ) \\ + {ρ}^{*} ( {g}_{0} , {g}_{1} ; L - u ) + {ρ}^{*} ( {g}_{2} , {g}_{3} ; L - u ) \\ + {ρ}^{*} ( {g}_{0} , - {g}_{1} ; L - u ) + {ρ}^{*} ( {g}_{2} , - {g}_{3} ; L - u ) = 0\end{matrix}$$

Case 2: For L≤u≤2L−1, Formula 5-2 is met, as shown below:

$${\sum }_{k = 0}^{3} ρ ( {c}_{k} ; u ) = ρ ( {g}_{1} , {g}_{0} ; u ) + ρ ( {g}_{3} , {g}_{2} ; u ) + ρ ( - {g}_{1} , {g}_{0} ; u ) + ρ ( - {g}_{3} , {g}_{2} ; u ) = 0$$

Case 3: For L≤u≤2L−1, Formula 5-2 is met, as shown below:

$${\sum }_{k = 0}^{3} ρ ( {c}_{k} , {c}_{( k + 1 ) mod 4} ; u ) = ρ ( {g}_{1} , {g}_{2} ; u - L ) + ρ ( {g}_{3} , {g}_{0} ; u - L ) + ρ ( - {g}_{1} , {g}_{2} ; u - L ) + ρ ( - {g}_{3} , {g}_{0} ; u - L ) = 0$$

With reference to the foregoing three cases, the (4, 2L, L)-CZCS is constructed in the construction manner 3. Incidentally, (4, L)-GCS can exist for various lengths, and hence the length of (4, 2L, L)-CZCS constructed in the construction manner 3 is flexible, thereby improving the feasibility of actual use of the system.

A construction manner 4 is similar to the construction manner 3. The CZCS {c₀, c₁, c₂, c₃} is also formed by concatenating sequences in a seed sequence set. A difference lies in that entries are further additionally added in the construction manner 4. Specifically, c₀=g₀∥+∥g₁, c₁=g₂∥−∥g₃, c₂=(−g₀)∥+∥g₁, and c₃=(−g₂)∥−∥g₃. The seed sequence set {g₀, g₁, g₂, g₃} is a (4, L)-GCS. The first T consecutive entries of the sequence g₁ and the sequence g₃ are the same, and T≤L−1. In this case, a (4, 2L+1, T)-CZCS is constructed based on a GCS {g₀, g₁, g₂, g₃}.

It is proved herein that the sequence set constructed in the construction manner 4 indeed belongs to the CZCS (meets Formula 5-1 and Formula 5-2), which is discussed in two cases. It is assumed gᵢ=(g_{i,0}, g_{i,1}, . . . , g_{i,L-1}), and i=0, 1, 2, 3.

Case 1:For 1≤u≤T,

$$\begin{matrix}{\sum }_{k = 0}^{3} ρ ( {c}_{k} ; u ) = 2 ( ρ ( {g}_{0} ; u ) + ρ ( {g}_{1} ; u ) + ρ ( {g}_{2} ; u ) + ρ ( {g}_{3} ; u ) ) \\ + {ρ}^{*} ( {g}_{0} , {g}_{1} ; L - u + 1 ) + {ρ}^{*} ( {g}_{2} , {g}_{3} ; L - u + 1 ) \\ + {ρ}^{*} ( {g}_{0} , - {g}_{1} ; L - u + 1 ) + {ρ}^{*} ( {g}_{2} , - {g}_{3} ; L - u + 1 ) \\ + {g}_{0 , L - u}^{*} - {g}_{2 , L - u}^{*} - {g}_{0 , L - u}^{*} + {g}_{2 , L - u}^{*} + 2 ( {g}_{1 , u} - {g}_{3 , u} ) \\ = 2 ( {g}_{1 , u} - {g}_{3 , u} ) = 0\end{matrix} .$$

Because the first T consecutive entries of the sequence g₀ and the sequence g₃ are the same, for 1≤u≤T, g_{1,u}=g_{3,u}.

Therefore, for L+1≤u≤2L, Formula 5-1 is met, as shown below:

$$\begin{matrix}{\sum }_{k = 0}^{3} ρ ( {c}_{k} ; u ) = ρ ( {g}_{1} , {g}_{0} ; u - L - 1 ) + ρ ( {g}_{3} , {g}_{2} ; u - L - 1 ) \\ + ρ ( {g}_{1} , - {g}_{0} ; u - L - 1 ) + ρ ( {g}_{3} , - {g}_{2} ; u - L - 1 ) = 0\end{matrix}$$

Case 2: For L+1≤u≤2L, Formula 5-2 is met, as shown below:

$$\begin{matrix}{\sum }_{k = 0}^{3} ρ ( {c}_{k} , {c}_{( k + 1 ) mod 4} ; u ) = ρ ( {g}_{1} , {g}_{2} ; u - L - 1 ) + ρ ( {g}_{3} , - {g}_{0} ; u - L - 1 ) \\ + ρ ( {g}_{1} , - {g}_{2} ; u - L - 1 ) + ρ ( {g}_{3} , {g}_{0} ; u - L - 1 ) = 0\end{matrix}$$

Because T₂={2L−T, 2L−T+1, . . . , 2L−1}⊆{L+1, L+2, . . . , 2L−1}, Formula 5-2 is also met.

With reference to the foregoing two cases, the (4, 2L+1, T)-CZCS is constructed in the construction manner 4. It is worth mentioning that the CZCS with odd lengths is constructed in this construction manner.

A construction manner 5 is similar to the construction manner 4. The CZCS {c₀, c₁, c₂, c₃} is formed by concatenating sequences in a seed sequence set, and entries are also additionally added. c₀=g₀∥+∥g₁, c₁=g₂∥−∥g₃ c₂=(−g₀)∥+∥g₁, and c₃=(−g₂)∥−∥g₃. A difference lies in that the seed sequence set {g₀, g₁, g₂, g₃} is constructed further through the seed sequence pair in the construction manner 5. Specifically, g₀=a∥e, g₁=b∥f, g₂=a∥(−e), and g₃=b∥(−f). The seed sequence set {g₀, g₁, g₂, g₃} is a (4, L₁+L₂)-GCS. The seed sequence pair (a, b) and the seed sequence pair (e, f) are GCPs with respective lengths of L₁ and L₂. The first L₁ consecutive entries of the sequence g₁ and the sequence g₃ are the same. In this case, a (4, 2L₁+2L₂+1, L₁)-CZCS is constructed based on the two GCPs (a, b) and (e, f).

A construction manner 6 is similar to the construction manner 3. The CZCS {c₀, c₁, c₂, c₃} is also formed by concatenating sequences in a GCS. A difference lies in that in the construction manner 6, each cross Z-complementary sequence is formed by concatenating sequences in a seed sequence set. Specifically, c₀=g₀∥g₁∥g₂∥g₃, c₁=g₀∥(−g₁)∥g₂∥(−g₃), c₂=g₀∥g₁∥(−g₂)∥(−g₃), and c₃=g₀∥(−g₁)∥(−g₂)∥g₃. The seed sequence set {g₀, g₁, g₂, g₃} is a (4, L)-GCS. In this case, a (4, 4L, 2L)-CZCS is constructed based on a GCS {g₀, g₁, g₂, g₃}.

It is proved herein that the sequence set constructed in the construction manner 6 indeed belongs to the CZCS (meets Formula 5-1 and Formula 5-2), which is discussed in two cases.

Case 1: Formula 5-1 is met, as shown below:

$$\begin{matrix}{\sum }_{k = 0}^{3} ρ ( {c}_{k} ; u ) = \{ \begin{matrix}4 ( ρ ( {g}_{0} ; u ) + ρ ( {g}_{1} ; u ) + ρ ( {g}_{2} ; u ) + ρ ( {g}_{3} ; u ) ) \\ + 2 ( {ρ}^{*} ( {g}_{0} , {g}_{1} ; L - u ) - {ρ}^{*} ( {g}_{0} , {g}_{1} ; L - u ) ) \\ + 2 ( {ρ}^{*} ( {g}_{1} , {g}_{2} ; L - u ) - {ρ}^{*} ( {g}_{1} , {g}_{2} ; L - u ) ) \\ + 2 ( {ρ}^{*} ( {g}_{2} , {g}_{3} ; L - u ) - {ρ}^{*} ( {g}_{2} , {g}_{3} ; L - u ) ) , \\ for 1 \leq u \leq L ; \\ 2 ( ρ ( {g}_{1} , {g}_{0} ; u - L ) - ρ ( {g}_{1} , {g}_{0} ; u - L ) ) \\ + 2 ( ρ ( {g}_{2} , {g}_{1} ; u - L ) - ρ ( {g}_{2} , {g}_{1} ; u - L ) ) \\ + 2 ( ρ ( {g}_{3} , {g}_{2} ; u - L ) - ρ ( {g}_{3} , {g}_{2} ; u - L ) ) \\ + 2 ( {ρ}^{*} ( {g}_{0} , {g}_{2} ; 2 L - u ) - {ρ}^{*} ( {g}_{0} , {g}_{2} ; 2 L - u ) ) \\ + 2 ( {ρ}^{*} ( {g}_{1} , {g}_{3} ; 2 L - u ) - {ρ}^{*} ( {g}_{1} , {g}_{3} ; 2 L - u ) ) , \\ for L \leq u < 2 L ; \\ 2 ( ρ ( {g}_{2} , {g}_{0} ; u - 2 L ) - ρ ( {g}_{2} , {g}_{0} ; u - 2 L ) ) \\ + 2 ( ρ ( {g}_{3} , {g}_{1} ; u - 2 L ) - ρ ( {g}_{3} , {g}_{1} ; u - 2 L ) ) \\ + 2 ( {ρ}^{*} ( {g}_{0} , {g}_{3} ; 3 L - u ) - {ρ}^{*} ( {g}_{0} , {g}_{3} ; 3 L - u ) ) , \\ for 2 L \leq u < 3 L ; \\ 2 ( ρ ( {g}_{3} , {g}_{0} ; u - 3 L ) - ρ ( {g}_{3} , {g}_{0} ; u - 3 L ) ) , \\ for 3 L \leq u < 4 L\end{matrix} \\ = \{ \begin{matrix}0 , & for 1 \leq u \leq L ; \\ 0 , & for L \leq u < 2 L ; \\ 0 , & for 2 L \leq u < 3 L ; \\ 0 , & for 3 L \leq u < 4 L\end{matrix}\end{matrix}$$

Case 2: Formula 5-2 is met, as shown below:

$$\begin{matrix}{\sum }_{k = 0}^{3} ρ ( {c}_{k} , {c}_{( k + 1 ) mod 4} ; u ) = \{ \begin{matrix}2 ( ρ ( {g}_{2} , {g}_{0} ; u - 2 L ) - ρ ( {g}_{2} , {g}_{0} ; u - 2 L ) ) \\ + 2 ( ρ ( {g}_{3} , {g}_{1} ; u - 2 L ) - ρ ( {g}_{3} , {g}_{1} ; u - 2 L ) ) \\ + 2 ( {ρ}^{*} ( {g}_{0} , {g}_{3} ; 3 L - u ) - {ρ}^{*} ( {g}_{0} , {g}_{3} ; 3 L - u ) ) , \\ for 2 L \leq u < 3 L ; \\ 2 ( ρ ( {g}_{3} , {g}_{0} ; u - 3 L ) - ρ ( {g}_{3} , {g}_{0} ; u - 3 L ) ) , \\ for 3 L \leq u < 4 L\end{matrix} \\ = \{ \begin{matrix}0 , & for 2 L \leq u < 3 L \\ 0 , & for 3 L \leq u < 4 L\end{matrix}\end{matrix}$$

With reference to the foregoing two cases, the (4, 4L, 2L)-CZCS is constructed in the construction manner 6.

Construction manner 7: The CZCS {c₀, c₁, c₂, c₃} is formed by concatenating sequences in a seed sequence pair. Specifically, c₀=a∥+∥b, c₁=a∥−∥b, c₂=(−a)∥+∥b, and c₃=(−a)∥−∥b. The seed sequence pair (a, b) is a GCP with a length of L. In this case, a (4, 2L+1, L+1)-CZCS is constructed based on a GCP (a, b).

It is proved herein that the sequence set constructed in the construction manner 7 indeed belongs to the CZCS (meets Formula 5-1 and Formula 5-2). Because the seed sequence pair (a, b) is a GCP, {a, b, a, b} is a GCS. It may be understood that according to the description of the foregoing construction manner 4, the CZCS is indeed constructed, as shown below:

$$\begin{matrix}{\sum }_{k = 0}^{3} ρ ( {c}_{k} ; u ) = 0 , & for all\end{matrix} u = 1 , 2 , … , 2 L$$

In addition,

$$\begin{matrix}{\sum }_{k = 0}^{3} ρ ( {c}_{k} , {c}_{( k + 1 ) mod 4} ; L ) = 2 ( ρ ( b , a ; - 1 ) + ρ ( b , - a ; - 1 ) ) \\ + 2 {a}_{0}^{*} + 2 {b}_{L - 1} - 2 {a}_{0}^{*} - 2 {b}_{L - 1} = 0\end{matrix}$$

Therefore, the ZCZ width is actually L+1, and the constructed sequence set is a (4, 2L+1, L+1)-CZCS.

Construction manner 8: The CZCS {c₀, c₁, c₂, c₃} is formed by bit-interleaving sequences in a seed sequence pair. Specifically, c₀=a *c, c₁=b*d, c₂=−(a*c), c₃=b*d, and (c, d)=(\tilde{b}*, −ã*). The seed sequence pair (a, b) is a (L, Z)-CZCP or a GCP with a length of L. In this case, a (4, 2L, 2Z+1)-CZCS is constructed based on a CZCP; or a (4, 2L, 2L)-CZCS is constructed based on a GCP (a, b).

It is proved herein that the sequence set constructed in the construction manner 8 indeed belongs to the CZCS (meets Formula 5-1 and Formula 5-2), which is discussed in two cases.

Case 1: For the even number u, Formula 5-1 is met, as shown below:

$${\sum }_{k = 0}^{3} ρ ( {c}_{k} ; u ) = 4 ( ρ ( a ; \frac{u}{2} ) + ρ ( b ; \frac{u}{2} ) ) = 0 ,$$

$$for \vert u \vert ∈ \{ 2 , 4 , … , 2 Z \} ⋃ \{ 2 L - 2 Z , 2 L - 2 Z + 2 , … , 2 L - 2 \}$$

This is because the sequence pair (a, b) is a (L, Z)-CZCP.

Case 2: For the odd number u, Formula 5-1 is met, as shown below:

$${\sum }_{k = 0}^{3} ρ ( {c}_{k} ; u ) = 2 ( ρ ( c , a ; \frac{u - 1}{2} ) + ρ ( d , b ; \frac{u - 1}{2} ) ) + 2 ( ρ ( a , c ; \frac{u + 1}{2} ) + ρ ( b , d ; \frac{u + 1}{2} ) )$$

$$= 0.$$

With reference to the foregoing two cases, it can be obtained as follows:

$$\begin{matrix}{\sum }_{k = 0}^{3} ρ ( {c}_{k} ; u ) = 0 , & \end{matrix} \qquad ( Formula 11 )$$

$$for \vert u \vert ∈ {T}_{1} ⋃ {T}_{2} \{ 1 , 2 , … , 2 Z + 1 \} ⋃ \{ 2 L - 2 Z - 1 , 2 L - 2 Z , … , 2 L - 1 \}$$

Case 3: For |u|∈{0, 1, 2, . . . , 2L−1},

$$\begin{matrix}{\sum }_{k = 0}^{3} ρ ( {c}_{k} , {c}_{( k + 1 ) mod 4} ; u ) \\ = ρ ( a ★ c , b ★ d ; u ) + ρ ( b ★ d , - a ★ c ; u ) \\ + ρ ( - a ★ c , b ★ d ; u ) + ρ ( b ★ d , a ★ c ; u ) = 0\end{matrix} .$$

With reference to the foregoing three cases, a (4, 2L, 2Z+1)-CZCS is constructed in the construction manner 8 based on a CZCP.

Further, if the seed sequence pair (a, b) is a GCP with a length of L, Z is substituted for L into Formula 11 to obtain T₁∪T₂={1, 2, . . . , 2L−1}, and the perfect (4, 2L, 2L)-CZCS is constructed.

Table 1 shows the CZCSs constructed in the foregoing construction manners 1 to 8. α, β, γ are positive integers.

TABLE 1

| Construction | | | | | |
|---|---|---|---|---|---|
| manner | Length | ZCZ width | ZCZ ratio ZCZᵣₐₜᵢₒ | Annotation | Basis |
| 1 | 2^{α}10^{β}26^{γ} | 2^{α}10^{β}26^{γ} | 1 | Perfect CZCS | GCP |
| | L | Z | $\frac{Z}{L}$ | | (L, Z)-CZCP |
| 2 | L₁ + L₂ | min(L₂, L₁ + Z₂) | $\frac{min ( {L}_{2} , {L}_{1} + {L}_{2} )}{{L}_{1} + {L}_{2}} > \frac{{Z}_{2}}{{L}_{2}}$ | L₁ ≤ L₂ | L₁ − GCP and (L₂, Z₂) − CZCP |
| 3 | 2L | L | $\frac{1}{2}$ | | (4, L)-GCS |
| 4 | 2L + 1 | T | $\frac{T}{2 L + 1}$ | T: It represents there are same T consecutive entries in two sequences in a GCS | (4, L)-GCS |
| 5 | 2L₁ + 2L₂ + 1 | L₁ | $\frac{{L}_{1}}{2 {L}_{1} + 2 {L}_{2} + 1}$ | | L₁ − GCP and L₂ − GCP |
| 6 | 4L | 2L | $\frac{1}{2}$ | | (4, L)-GCS |
| 7 | 2^{α+1}10^{β}26^{γ} + 1 | 2^{α+1}10^{β}26^{γ} + 1 | $> \frac{1}{2}$ | | GCP |
| 8 | 2^{α+1}10^{β}26^{γ} | 2^{α+1}10^{β}26^{γ} | 1 | Perfect CZCS | GCP |
| | 2L | 2Z + 1 | $\frac{2 Z + 1}{2 L} > \frac{Z}{L}$ | | (L, Z)-CZCP |

In some embodiments, the sequence generation circuit 110 is connected to the communication circuit 130 (as shown in FIG. 1). In some other embodiments, the sequence generation circuit 110 is located in the communication circuit 130 (as shown in FIG. 2).

In some embodiments, the sequence generation circuit 110 is implemented as a microprocessor, a complex programmable logical device (CPLD), a field programmable gate array (FPGA), a logic circuit, an analog circuit, a digital circuit, and/or any processing element based on an operation instruction and an operation signal (analog and/or digital). The sequence generation circuit 110 performs the foregoing method for generating training sequences to generate a training sequence matrix Λ.

In some embodiments, the sequence generation circuit 110 further includes an internal memory. The internal memory is configured to store the seed sequence pair or the seed sequence set used for constructing the CZCS. In some embodiments, the sequence generation circuit 110 is coupled to an external memory. The external memory is configured to store the seed sequence pair or the seed sequence set used for constructing the CZCS. The internal memory and the external memory are non-transitory computer-readable recording media (for example, flash memories). In some embodiments, if the seed sequence pair is used for constructing the seed sequence set (in the construction manner 5), the internal memory and the external memory may store the seed sequence pair only, and do not store the seed sequence set.

To avoid redundant description content, it is not mentioned in this specification that the communication circuit 130 may further include a receive antenna. A person skilled in the art of the present invention should understand that the communication circuit 130 may further include one or more receive antennas, and use the foregoing training sequences for communication.

In summary, the spatial modulation system according to some embodiments of the present invention can achieve good channel estimation performance on frequency selective channels. In the method for generating training sequences according to some embodiments of the present invention, a larger zero correlation zone (ZCZ) width can be constructed (or even the ZCZ ratio ZCZᵣₐₜᵢₒ can reach 1), so that the training sequences can resist a larger channel propagation delay; and the constructed sequence set has flexible lengths (including even lengths and odd lengths), thereby improving the actual usability of the system.

What is claimed is:

1. A method for generating training sequences, comprising:
obtaining a cross Z-complementary set (CZCS), wherein the CZCS comprises N cross Z-complementary sequences c₀˜c_{N-1}, and a length of each of the cross Z-complementary sequences is L; and
obtaining a training sequence matrix Λ according to the cross Z-complementary sequences, wherein
$$Λ = [ \begin{matrix}{x}_{1} \\ {x}_{2} \\ ⋮ \\ {x}_{{N}_{t}}\end{matrix} ] = {[ \begin{matrix}{c}_{0} & 0 & … & 0 & {c}_{1} & 0 & … & 0 & {c}_{2} & 0 & … & 0 & & {c}_{N - 1} & 0 & … & 0 \\ 0 & {c}_{0} & … & 0 & 0 & {c}_{1} & … & 0 & 0 & {c}_{2} & … & 0 & … & 0 & {c}_{N - 1} & … & 0 \\ ⋮ & ⋮ & ⋱ & ⋮ & ⋮ & ⋮ & ⋱ & ⋮ & ⋮ & ⋮ & ⋱ & ⋮ & & ⋮ & ⋮ & ⋱ & ⋮ \\ 0 & 0 & … & {c}_{0} & 0 & 0 & … & {c}_{1} & 0 & 0 & … & {c}_{2} & & 0 & 0 & … & {c}_{N - 1}\end{matrix} ]}_{{N}_{t} \times {NN}_{t} L}$$
wherein 0 is a zero vector 0_{1xL}.

2. The method for generating training sequences according to claim 1, wherein the CZCS is formed by amplifying a seed sequence pair.

3. The method for generating training sequences according to claim 2, wherein N=4, {c₀, c₁, c₂, c₃}={a, b, −a, b}, {−a, b, a, b}, {a, −b, a, b} or {a, b, a, −b}, and the seed sequence pair is a cross Z-complementary pair (CZCP) or a Golay complementary pair (GCP).

4. The method for generating training sequences according to claim 1, wherein the CZCS is formed by concatenating sequences in two seed sequence pairs.

5. The method for generating training sequences according to claim 4, wherein N=4, {c₀, c₁, c₂, c₃}={a∥c, b∥d, (−a)∥c, (−b)∥d}, each of the two seed sequence pairs (a, b) and (c, d) is a GCP, and (c, d) is also a CZCP.

6. The method for generating training sequences according to claim 1, wherein the CZCS is formed by concatenating sequences in a seed sequence set.

7. The method for generating training sequences according to claim 6, wherein N=4, {c₀, c₁, c₂, c₃}={g₀∥g₁, g₂∥g₃, g₀∥(−g₁), g₂∥(−g₃)}, and the seed sequence set {g₀, g₁, g₂, g₃} is a Golay complementary set (GCS).

8. The method for generating training sequences according to claim 6, wherein N=4, and {c₀, c₁, c₂, c₃}={g₀∥+∥g₁, g₂∥−∥g₃, (−g₀)∥+∥g₁, (−g₂)∥−∥g₃}, wherein + represents 1, − represents −1, the seed sequence set {g₀, g₁, g₂, g₃} is a GCS, the first T consecutive entries of the sequence g₀ and the sequence g₃ are the same, T≤L−1, and L is a length of the Golay complementary sequences in the GCS.

9. The method for generating training sequences according to claim 6, wherein N=4, and {c₀, c₁, c₂, c₃}={g₀∥+∥g₁, g₂∥−∥g₃, (−g₀)∥+∥g₁, (−g₂)∥−∥g₃}, wherein + represents 1, − represents −1, the seed sequence set {g₀, g₁, g₂, g₃}={a∥e, b∥f, a∥(−e), b∥(−f)}, and each of the two seed sequence pairs (a, b) and (e, f) is a GCP.

10. The method for generating training sequences according to claim 6, wherein N=4, {c₀, c₁, c₂, c₃}={g₀∥g₁∥g₂∥g₃, g₀∥(−g₁)∥g₂∥(−g₃), g₀∥g₁∥(−g₂)∥(−g₃), g₀∥(−g₁)∥(−g₂)∥g₃}, and the seed sequence set {g₀, g₁, g₂, g₃} is a GCS.

11. The method for generating training sequences according to claim 1, wherein the CZCS is formed by concatenating sequences in a seed sequence pair.

12. The method for generating training sequences according to claim 11, wherein N=4, {c₀, c₁, C₂, c₃}={a∥+∥b, a∥−∥b, (−a)∥+∥b, (−a)∥−∥b}, and the seed sequence pair (a, b) is a GCP.

13. The method for generating training sequences according to claim 1, wherein the CZCS is formed by bit-interleaving sequences in a seed sequence pair.

14. The method for generating training sequences according to claim 13, wherein N=4, {c₀, c₁, c₂, c₃}={a*c, b*d, −(a*c), b*d}, and (c, d)=(\tilde{b}*, −ã*), wherein * represents a bit-interleaved operation, ã represents reverse of a sequence a, ã* represents a complex conjugate sequence of a sequence ã, and the seed sequence pair (a, b) is a CZCP or a GCP.

15. A spatial modulation system, comprising:
a sequence generation circuit, configured to perform the method for generating training sequences according to claim 1; and
a communication circuit, configured to transmit the training sequence matrix.
